(19) United States
(12) Patent Application Publication
(10) Pub. No.: US 2015/0358795 A1
(43) Pub. Date: Dec. 10, 2015

(54) Browser emergency call method, system, and mobile device in real-time communication

(71) Applicant: ZTE CORPORATION, Guangdong (CN)

(72) Inventors: Shilin You, Shenzhen (CN); Zhenwu Hao, Shenzhen (CN)

(73) Assignee: ZTE CORPORATION, Shenzhen, Guangdong (CN)

(21) Appl. No.: 14/442,451

(22) PCT Filed: Aug. 27, 2013
(86) PCT No.: PCT/CN2013/082378

§ 371 Date: May 13, 2015

(30) Foreign Application Priority Data
Nov. 13, 2012 (CN) 201210454082.8

(51) Int. Cl. H04W 4/22; H04W 4/02; H04W 76/00

(52) U.S. Cl. CPC H04W 4/22; H04W 76/007; H04W 4/02

(57) ABSTRACT

Disclosed is an emergency call method for a real-time communication browser. A signaling server acquires location information of a user who makes an emergency call through a browser, determines an emergency communication server connected between the signaling server and a PSAP nearest to the user according to the location information, and sends an emergency service request to the emergency communication server or returns an emergency call request response to the browser that then sends an emergency service request to the emergency communication server. The emergency communication server forwards the emergency service request to the PSAP. An emergency call system for a real-time communication browser and a mobile device are disclosed. Through solutions of the disclosure, an emergency communication server may be deployed or a mobile communication network may be selected to initiate a browser emergency call, so as to implement a cross-region emergency call for an RTCWEB system.

### TECHNICAL FIELD

The disclosure relates to an emergency call technology for networks, in particular to an emergency call method and an emergency call system for a real-time communication browser, and a mobile device.

### BACKGROUND

According to the control regulations of the government, a telecommunication network must provide the emergency voice call service. When a user dials an emergency call number or uses a default emergency call number stored in terminal equipment or an emergency call identifier to initiate an emergency call, the telecommunication network connects the emergency call to a local Public Safety Answering Point (PSAP), such as police, fire alarm, medical aid and rescue.

An Internet Protocol (IP) Multimedia Core Network Subsystem (IMS) is also required to provide the emergency call service.

FIG. 1 is a reference framework of an emergency call system for an IMS. The whole framework includes User Equipment (UE) 101, Proxy Call Session Control Function (P-CSCF) 102, Serving Call Session Control Function (S-CSCF) 103, a Home Subscriber Server (HSS) 104, Emergency Call Session Control Function (E-CSCF) 105, Location Retrieval Function (LRF) 106 and a PSAP 107. In addition, Interconnection Border Control Function (IBCF), Interrogating Call Session Control Function (I-CSCF), Media Gateway Control Function (MGCF), a Media Gateway (MGW) and other functional entities are further involved in a session process.

The E-CSCF 105, which is a new functional entity introduced in an IMS domain and is located in the same network of the P-CSCF 102 (serving as a visited network for a roaming user), is responsible for receiving an emergency session establishment request from the P-CSCF 102, and routing the emergency session establishment request to the PSAP 107 connected with an IP network through an Mm interface according to the location information provided by a user or according to the location information and routing information acquired from the LRF 106, or routing the emergency session establishment request to the PSAP 107 connected with a Public Switched Telephone Network (PSTN) through an Mi/Mg interface. The PSAP 107 can directly acquire the location information of the user from the LRF 106 through an Le interface and contact with a home network through an Mm/Mw interface.

According to different roaming states of the user and different network locations where the user accesses the P-CSCF, a call may be made in the following scenarios:

Scenario 1: the user does not roam (i.e., be in the home network), and the P-CSCF is located in the home network;

Scenario 2: the user roams (i.e., be in the visited network), while the P-CSCF is located in the home network; and

Scenario 3: the user roams (i.e., be in the visited network) and the P-CSCF is located in the visited network.

The existing mobile communication network also supports an emergency call. When the user dials an emergency call number, a mobile communication system may allocate resources to the emergency call preferably in a circuit domain to ensure that the emergency call is normal, and may further call a PSAP nearby to ensure that the emergency call is handled quickly.

With the increasing integration between the communication network and the Internet, the demand on communication among various parties is more and more complex. The communication is not only in a single audio form, and may also in a video form or in a mixed form of other media, and even the timeliness is sometimes required.

The existing browsers are of a Client/Server (C/S) structure. Websites generally provide a real-time media service, such as audio or video, through the plug-in technology or download. The existing webpage technology, even the existing Hypertext Transfer Protocol (HTTP) technology, cannot support the streaming media transmission well. Thus, the real-time communication based on browsers has defects, and the efficiency of browsers has to be realized and accelerated by a plug-in/a plug-in application program or download.

To solve the technical problems above, with a Peer-to-Peer (P2P) browser technology as a P2P communication technology between browsers, the browsers can transmit contents, including video, audio and supplement for real-time communication according to the characteristics of the P2P in real time.

Now, the research topic of a Real-Time Communication (RTC) web is actually a direct P2P communication standard between two browsers, which does not need a central server. This standard can reduce man-made interference and sniffing, thereby improving the reliability of Internet communication. This new real-time communication concept is realized by an Application Programming Interface (API) of a client. The API can be invoked directly by a browser manufacturer and be used without downloading a plug-in or an application program additionally.

The RTCWEB working group in the IETF was set up in July 2011, and mainly aims to cooperate with the RTCWEB working group of World Wide Web Consortium (W3C) to implement real-time video and audio communication directly through a browser without the support of the plug-in.

The standards involved in the IETF include: rules of using a data transmission protocol, a media transmission protocol, a Real-time Transport Protocol (RTP)/a Secure Real-time Transport Protocol (SRTP), a session connection and control, a media data format, a browser local support and the like. The data transmission protocol contains a Network Address Translation (NAT) traversal and the like. The session connection and control contains how to establish a session, how to carry out media negotiation, etc. The media data format includes a required coding format, an optional coding format, and the like. The browser local support includes basic local device control, such as volume and camera focus.

The RTCWEB working group attracts many Internet giants and traditional telecommunication industries, such as Ericsson, as soon as it is set up. Many companies implemented the prototype of the RTCWEB and demonstrated it.

FIG. 2 is a diagram showing a basic architecture of an existing RTCWEB service, which mainly includes the following network elements:

a signaling server, which is mainly responsible for user registration, user addressing, session state maintenance of a browser; and browsers (A, B), which are mainly responsible for the interface display of a user terminal, and initiating and accepting a session to establish a media connection with a target browser.

When preparing to establish a real-time communication session with browser B, browser A sends a session request to a registered signaling server A through the HTTP or a web socket. The session request message includes the Identifier (ID) of the target browser B and media address information of the browser A. The signaling server A determines that the user has been registered in the signaling server B by analyzing the ID of the browser B and sends a session request to the signaling server B through an SIP. The signaling server B sends a session request message to the browser B through the HTTP according to the registered address of a browser B user. The session request message includes a media port IP address and port information of the browser A. Browser B accepts this session, and returns an acknowledgement message to return its media address and port information.

Thus, browser A and browser B establish a real-time communication.

Regarding the emergency service for browser A, browser A can make a call on any terminal with RTCWEB (a desktop computer, a laptop and even a mobile terminal), so like the P-CSCF of the IMS, the corresponding signaling server A of browser A may be in a visited domain or a home domain. If browser A is directly routed to the PSAP, a remote alarm may occur, and the emergency call may therefore not be handled timely and quickly. In addition, for the mobile terminals with the RTCWEB, the emergency call cannot be handled until an RTCWEB emergency system is deployed.

### SUMMARY

Embodiments of the disclosure provide an emergency call method and an emergency call system for a real-time communication browser and a mobile device, which can implement cross-region emergency call for an RTCWEB system.

The technical solution of the embodiment of the disclosure is implemented as follows:

An emergency call method for a real-time communication browser provided by the embodiment of the disclosure includes the following steps:

a signaling server acquires location information of a user who makes an emergency call through a browser, determines an emergency communication server connected between the signaling server and a PSAP nearest to the user according to the location information, and sends an emergency service request to the emergency communication server or returns an emergency call request response to the browser that then sends an emergency service request to the emergency communication server; and the emergency communication server forwards the emergency service request to the PSAP.

In an example, the step that a signaling server acquires the location information of a user who makes an emergency call through a browser may include that: the signaling server receives an emergency call request which is sent by the user through the browser, wherein the emergency call request includes an IP address of the user, longitude and latitude of a location of the browser, or a location parameter of a mobile user; the signaling server acquires the location information of the user according to the emergency call request.

In an example, the step that a signaling server acquires the location information of a user who makes an emergency call through a browser may include that: the signaling server receives an ordinary call request which is sent by a user through the browser, wherein the ordinary call request includes a service code and one of the following: an IP address of the user, longitude and latitude of a location of the browser, and a location parameter of the mobile user; the signaling server determines whether the ordinary call request is an emergency call request by determining whether the service code is an emergency call service code; when the ordinary call request is an emergency call request, the signaling server acquires the location information of the user according to the emergency call request.

In an example, the step that a signaling server acquires the location information of a user who makes an emergency call through a browser may include that: the signaling server receives the emergency call request which is sent by the user through the browser and acquires the location information of the user through a location server.

In an example, the step that the signaling server determines an emergency communication server connected between the signaling server and the PSAP nearest to the user according to the location information may include that: the PSAP nearest to the user is searched for through the Internet according to the location information, and an IP address of the emergency communication server connected between the signaling server and the PSAP is determined according to an route of the PSAP.

In an example, the emergency service request includes at least one of the following: information about the PSAP, and the location information of the user, wherein the information about the PSAP is an IP address of the PSAP or number of the PSAP.

In an example, the method may further include that: the PSAP, after receiving the emergency service request, responds to the emergency service request and returns an emergency service request response.

An embodiment of the disclosure provides an emergency cal system for a real-time communication browser, which includes a browser, a signaling server, an emergency communication server, and a PSAP.

The browser is configured to initiate an emergency call, and to send an emergency service request to the emergency communication server after receiving an emergency call request response;

the signaling server is configured to acquire location information of a user who makes an emergency call through the browser, to determine the emergency communication server connected between the signaling server and the PSAP nearest to the user according to the location information, and to send an emergency service request to the emergency communication server or return an emergency call request response to the browser.

The emergency communication server is configured to forward the emergency service request to the PSAP.

The PSAP is configured to receive the emergency service request from the emergency communication server.

In an example, the signaling server is configured to: receive the emergency call request which is sent by the user through the browser, wherein the emergency call request includes an IP address of the user, longitude and latitude of a location of the browser, or an location parameter of a mobile user; and acquire the location information of the user who makes an emergency call through the browser according to the emergency call request.

In an example, the signaling server is configured to: receive an ordinary call request which is sent by a user through the browser, wherein the ordinary call request includes a service code and one of the following: an IP address of the user, longitude and latitude of a location of the browser, and a location parameter of the mobile user; determine whether the ordinary call request is an emergency call request by determining whether the service code is an emergency call service code; and, when the ordinary call request is an emergency call request, acquire the location information of the user who makes an emergency call through the browser according to the emergency call request.

In an example, the signaling server is configured to receive an emergency call request which is sent by the user through the browser and acquire the location information of the user through a location server.

In an example, the emergency service request includes at least one of the following: information about the PSAP, and the location information of the user, wherein the information about the PSAP is an IP address or number of the PSAP.

In an example, the PSAP may be further configured to, after receiving the emergency service request, respond to the emergency service request and return an emergency service request response.

An embodiment of the disclosure provides an emergency call method for the real-time communication browser, which includes the following steps:

when an emergency call is to be initiated, a browser sends an emergency service request to a mobile communication module by using a Java script function; the mobile communication module initiates an emergency call in a mobile communication system according to the emergency service request.

In an example, before the emergency service request is sent to the mobile communication module by using the Java script function, the method may further include:

the browser determines that the current call request is an emergency service request according to a service code in the current call request; or the browser sends the current call request to a signaling server, and the signaling server determines that the current call request is an emergency service request according to a service code in the current call request and returns an emergency service request with an emergency call identifier to the browser.

An embodiment of the disclosure provides a mobile device, which includes a browser module, a call module, and a mobile communication module.

The browser module is configured to send an emergency service request to the call module when an emergency call is to be initiated;

the call module is configured to send the emergency service request to the mobile communication module by using a Java script function; and

the mobile communication module is configured to initiate an emergency call in a mobile communication system according to the emergency service request.

In an example, the browser module may be further configured to: before sending the emergency service request to the call module,

determine that the current call request is an emergency service request according to a service code in the current call request; or

send the current call request to a signaling server and receive the emergency service request with an emergency call identifier from the signaling server.

Embodiments of the disclosure provide an emergency call method and an emergency call system for the real-time communication browser, and a mobile device. A signaling server acquires location information of a user who makes an emergency call through the browser, determines an emergency communication server connected between the signaling server and a PSAP nearest to the user according to the location information, and sends an emergency service request to the emergency communication server or returns an emergency call request response to the browser that then sends an emergency service request to the emergency communication server. The emergency communication server forwards the emergency service request to the PSAP. By means of the solution of the disclosure, an emergency communication server can be deployed or a mobile communications network can be selected to perform browser emergency call, thereby implementing a cross-region emergency call of an RTCWEB system.

### BRIEF DESCRIPTION OF THE DRAWINGS

FIG. 1 is a diagram showing the architecture of an emergency call system for an IMS in the related art;

FIG. 2 is a diagram showing a basic architecture of an RTCWEB service in the related art;

FIG. 3 is a diagram showing the flow of an emergency call method for a real-time communication browser provided by an embodiment of the disclosure;

FIG. 4 is a diagram showing the structure of an emergency call system for a real-time communication browser provided by an embodiment of the disclosure;

FIG. 5 is a diagram showing the flow of an emergency call method for a real-time communication browser provided by Embodiment 1 of the disclosure;

FIG. 6 is a diagram showing the flow of an emergency call method for a real-time communication browser provided by Embodiment 2 of the disclosure;

FIG. 7 is a diagram showing the flow of an emergency call method for a real-time communication browser provided by Embodiment 3 of the disclosure;

FIG. 8 is a diagram showing the flow of an emergency call method for a real-time communication browser provided by Embodiment 4 of the disclosure;

FIG. 9 is a diagram showing the flow of an emergency call method for a real-time communication browser in a mobile device provided by an embodiment of the disclosure; and

FIG. 10 is a diagram showing the structure of a mobile device provided by an embodiment of the disclosure.

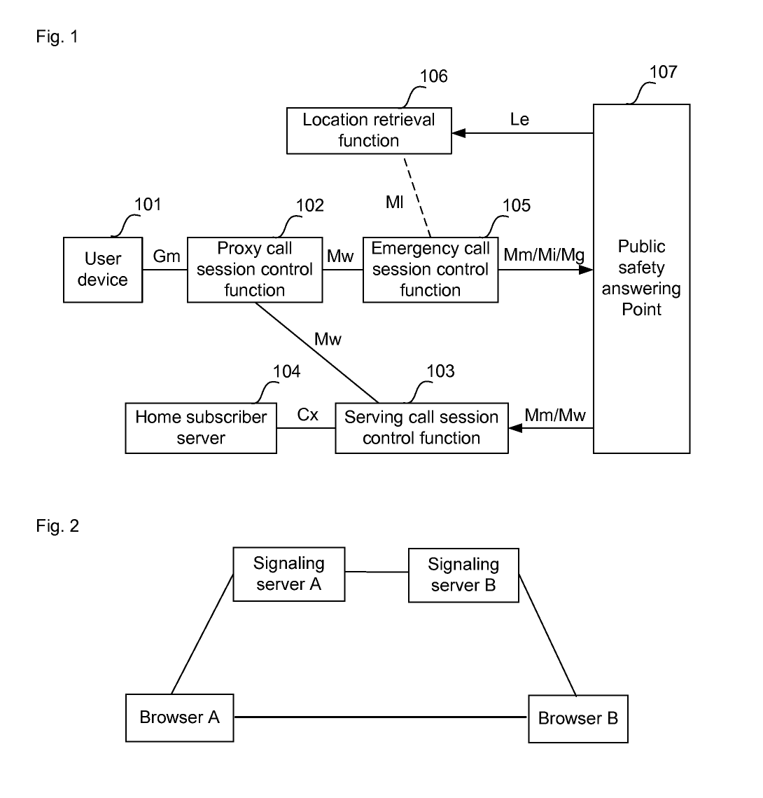

### DETAILED DESCRIPTION

In an embodiment of the disclosure, a signaling server acquires location information of a user who makes an emergency call through a browser, determines an emergency communication server connected between the signaling server and a PSAP nearest to the user according to the location information, and sends an emergency service request to the emergency communication server or returns an emergency call request response to the browser that then sends an emergency service request to the emergency communication server; and the emergency communication server forwards the emergency service request to the PSAP.

The disclosure is further described below with reference to the accompanying drawings and embodiments in detail.

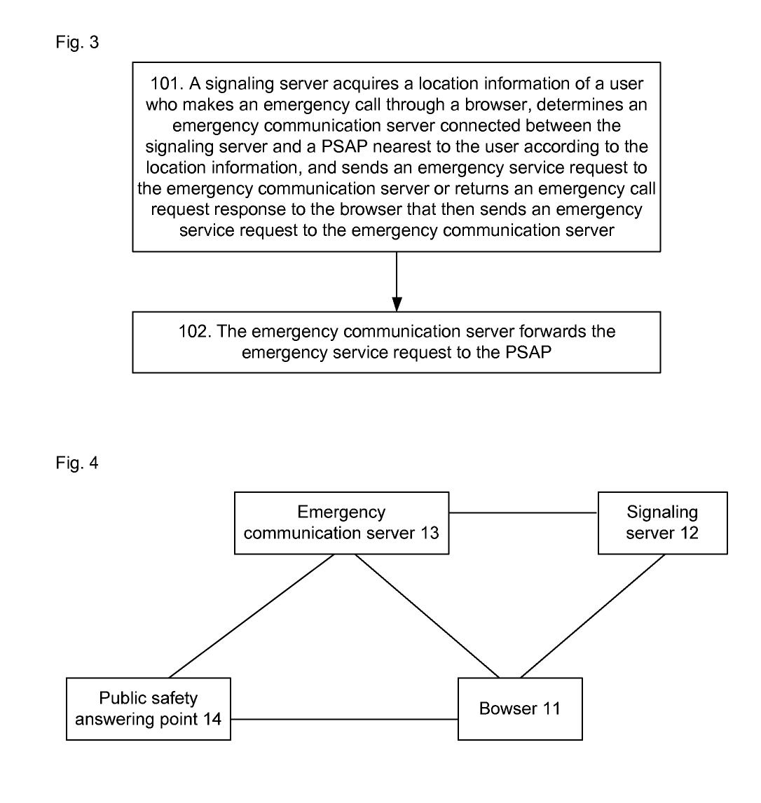

An embodiment of the disclosure provides an emergency call method for a real-time communication browser. As shown in FIG. 3, the method includes the following steps:

In Step 101, a signaling server acquires location information of a user who makes an emergency call through a browser, determines an emergency communication server connected between the signaling server and a PSAP nearest to the user according to the location information, and sends an emergency service request to the emergency communication server or returns an emergency call request response to the browser that then sends an emergency service request to the emergency communication server.

Preceding Step 101, the method may further include the following step: an emergency communication server is arranged in the RTCWEB. The emergency communication server is connected with the signaling server, the PSAP and the browser.

In Step 101, the step that a signaling server acquires the location information of a user who makes an emergency call through a browser may include that: the signaling server receives an emergency call request sent by the user through the browser and acquires the location information of the user according to the emergency call request; the emergency call request includes an IP address of the user, longitude and latitude of a location of the browser, or a location parameter of a mobile user; the location information may be longitude and latitude, a cell location information of a mobile user, or a physical location corresponding to the IP address.

The step that a signaling server acquires the location information of a user who makes an emergency call through a browser may further include that: the signaling server receives an ordinary call request sent by a user through the browser, which includes a service code and one of the following: an IP address of the user, longitude and latitude of a location of the browser, and a location parameter of the mobile user; and the signaling server determines whether the ordinary call request is an emergency call request by determining whether the service code is an emergency call service code, and when the service code is an emergency call service code, namely, the ordinary call request is an emergency call request, acquires the location information of the user according to the emergency call request. The location information may be longitude and latitude, cell location information of a mobile user, or a physical location corresponding to the IP address.

The step that a signaling server acquires the location information of a user who makes an emergency call through a browser may further include that: the signaling server receives the emergency call request sent by the user through the browser and acquires the location information of the user through a location server.

The step that the signaling server determines an emergency communication server connected between the signaling server and the PSAP nearest to the user according to the location information may include that: the PSAP nearest to the user is searched for through the Internet according to the location information, and an IP address of an emergency communication server connected between the signaling server and the found PSAP is determined according to an route of the found PSAP.

The emergency call request response includes the IP address of the emergency communication server and at least one of the following: information about the PSAP, and the location information of the user; the information about the PSAP is an IP address of the PSAP or number of the PSAP.

The emergency service request includes at least one of the following: information about the PSAP, and the location information of the user; the information about the PSAP is an IP address of the PSAP or number of the PSAP.

Step 101 may further include that: the browser detects whether an emergency communication server at a consistent location is stored therein; if no emergency communication server at a consistent location is stored, an emergency call is made to the signaling server; if an emergency communication server at a consistent location is stored, an emergency service request is directly sent to the emergency communication server. The emergency service request includes at least one of the following: information about the PSAP, and the location information of the user, wherein the information about the PSAP is an IP address of the PSAP or number of the PSAP.

The emergency communication server at a consistent location is one which is consistent with the browser in location.

In Step 102, the emergency communication server forwards the emergency service request to the PSAP.

Specifically, the emergency communication server forwards the emergency service request to a corresponding PSAP according to information included in the received emergency service request; the information includes at least one of the following: information about the PSAP, and the location information of the user; the information about the PSAP is an IP address of the PSAP or number of the PSAP.

The method may further include that: the PSAP, after receiving the emergency service request, responds to the emergency service request, and returns an emergency service request response to the browser through the emergency communication server and the signaling server.

To implement the above method, an embodiment of the disclosure further provides an emergency call system for a real-time communication browser. As shown in FIG. 4, the system includes a browser 11, a signaling server 12, an emergency communication server 13 and a PSAP 14.

The browser 11 is configured to initiate an emergency call, and to send an emergency service request to the emergency communication server 13 after receiving an emergency call request response;

the signaling server 12 is configured to acquire location information of a user who makes an emergency call through the browser 11, to determine the emergency communication server 13 connected between the signaling server 12 and the nearest PSAP 14 of the user according to the location information, and to send an emergency service request to the emergency communication server 13 or return an emergency call request response to the browser 11;

the emergency communication server 13 is configured to forward the emergency service request to the PSAP 14; and

the PSAP 14 is configured to receive the emergency service request from the emergency communication server 13.

The signaling server 12 is configured to receive the emergency call request sent by the user through the browser 11, which includes an IP address of the user, longitude and latitude of a location of the browser, or a location parameter of a mobile user. The signaling server 12 is further configured to acquire a location information of the user who makes an emergency call through the browser 11 according to the emergency call request.

The signaling server 12 is configured to receive an ordinary call request sent by a user through the browser 11, which includes a service code and one of the following: an IP address of the user, longitude and latitude of a location of the browser, and a location parameter of a mobile user. The signaling server 12 is further configured to determine whether the ordinary call request is an emergency call request by determining whether the service code is an emergency call service code, and when the service code is an emergency call service code, namely the ordinary call request is the emergency call request, to acquire the location information of the user who makes an emergency call through the browser 11 according to the emergency call request.

The location information may be longitude and latitude, cell location information of a mobile user, or a physical location corresponding to the IP address.

The signaling server 12 is configured to receive the emergency call request which is sent by the user through the browser 11 and acquire the location information of the user through a location server.

The emergency call request response includes the IP address of the emergency communication server 13 and at least one of the following: information about the PSAP 14, and the location information of the user; the information about the PSAP 14 is an IP address of the PSAP or number of the PSAP.

The emergency service request includes at least one of the following: information about the PSAP 14, and the location information of the user; the information about the PSAP 14 is an IP address of the PSAP or number of the PSAP.

The emergency communication server 13 is configured to forward the emergency service request to a corresponding PSAP 14 according to information included in the received emergency service request; the information included in the received emergency service request includes at least one of the following: information about the PSAP 14, and the location information of the user, wherein the information about the PSAP is an IP address of the PSAP 14 or number of the PSAP 14.

The PSAP 14 may be further configured to, after receiving the emergency service request, respond to the emergency service request and return an emergency service request response to the browser 11 through the emergency communication server 13 and the signaling server 12.

The implementation process and principle of the method provided by the disclosure are described below in combination with specific embodiments in detail.

### Embodiment 1

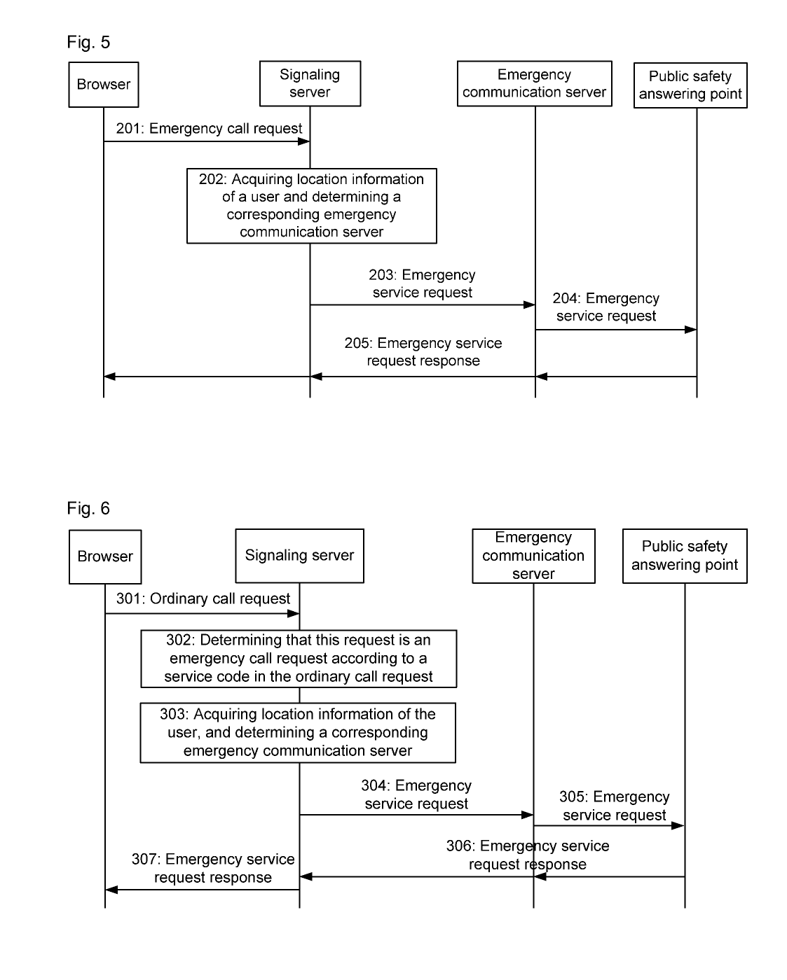

The embodiment of the disclosure provides an emergency call method for a real-time communication browser. As shown in FIG. 5, the method includes the following steps:

In Step 201, a browser of a user sends an emergency call request to a signaling server. The emergency call request includes an IP address of the user, longitude and latitude of a location of the browser, or a location parameter of a mobile user.

In Step 202, the signaling server acquires the location information of the user who makes an emergency call through the browser according to the emergency call request, and determines an emergency communication server connected between the signaling server and a PSAP nearest to the user according to the location information.

In Step 203, the signaling server sends the emergency communication server an emergency service request that includes the location information of the user.

In Step 204, the emergency communication server determines a PSAP according to the location information of the user and forwards the emergency service request to a found PSAP.

In Step 205, the PSAP returns an emergency service request response message to the browser through the emergency communication server and the signaling server to respond to the emergency service request.

### Embodiment 2

The embodiment of the disclosure provides an emergency call method for a real-time communication browser. As shown in FIG. 6, the method includes the following steps:

In Step 301, a browser of a user sends an ordinary call request to a signaling server. The ordinary call request includes a service code and one of the following: an IP address of the user, longitude and latitude of a location of the browser, and a location parameter of a mobile user. For example, the service code is 110 that is a police number, or is 119 that is a fire alarm number.

In Step 302, the signaling server determines that the ordinary call request is an emergency call request according to the service code.

In Step 303, the signaling server acquires location information of the user who makes an emergency call through the browser according to the emergency call request, and determines an emergency communication server connected between the signaling server and a PSAP nearest to the user according to the location information.

In Step 304, the signaling server sends the emergency communication server an emergency service request message that includes the location information of the user.

In Step 305, the emergency communication server determines a PSAP according to the location information of the user and forwards the emergency service request to the PSAP.

In Step 306, the PSAP returns an emergency service request response message to the signaling server through the emergency communication server to respond to the emergency service request.

In Step 307, the signaling server returns a service request response message to the browser.

### Embodiment 3

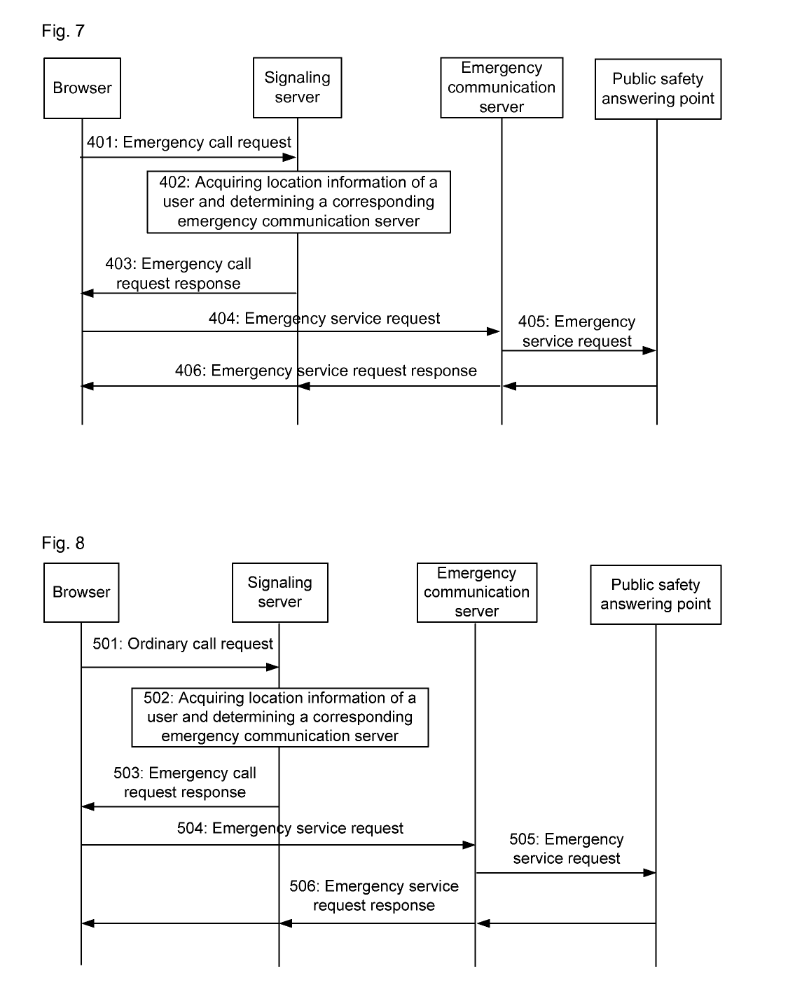

The embodiment of the disclosure provides an emergency call method for a real-time communication browser. As shown in FIG. 7, the method includes the following steps:

In Step 401, a browser of a user detects whether an address of an emergency communication server at a consistent location is stored; if not, an emergency call request is made to a signaling server. The emergency call request includes an IP address of the user, longitude and latitude of a location of the browser, or a location parameter of a mobile user (e.g., cell information).

When an address of an emergency communication server at a consistent location is stored, Step 404 is executed directly.

In Step 402, the signaling server acquires location information of the user who makes an emergency call through the browser according to the emergency call request, and determines an emergency communication server connected between the signaling server and a PSAP nearest to the user according to the location information.

In Step 403, the signaling server sends the browser an emergency call request response, which includes at least one of the following: an address of the emergency communication server, and the location information of the user.

In Step 404, the browser of the user sends an emergency service request to the emergency communication server, which includes the location information of the user.

In Step 405, the emergency communication server determines a PSAP according to the location information of the user and forwards the emergency service request to the PSAP.

In Step 406, the PSAP returns an emergency service request response message to the browser through the emergency communication server to respond to the emergency service request.

### Embodiment 4

The embodiment of the disclosure provides an emergency call method for a real-time communication browser. As shown in FIG. 8, the method includes the following steps:

In Step 501, a browser of a user sends an ordinary call request to a signaling server. The ordinary call request includes a service code and at least one of the following: an IP address of the user, longitude and latitude of a location of the browser, and a location parameter of a mobile user. For example, the service code is 110 that is a police number, or is 119 that is a fire alarm number.

In Step 502, the signaling server determines that the ordinary call request is an emergency call request according to the service code, acquires the location information of the user who makes an emergency call through the browser according to the emergency call request, and determines an emergency communication server connected between the signaling server and a PSAP nearest to the user according to the location information.

In Step 503, the signaling server returns an emergency call request response to the browser. The emergency call request response includes at least one of the following: an address of the emergency communication server, and the location information of the user.

In Step 504, the browser of the user sends the emergency communication server an emergency service request message that includes the location information of the user.

In Step 505, the emergency communication server determines a PSAP according to the location information of the user and forwards the emergency service request to the PSAP.

In Step 506, the PSAP returns an emergency service request response message to the browser through the emergency communication server to respond to the emergency service request.

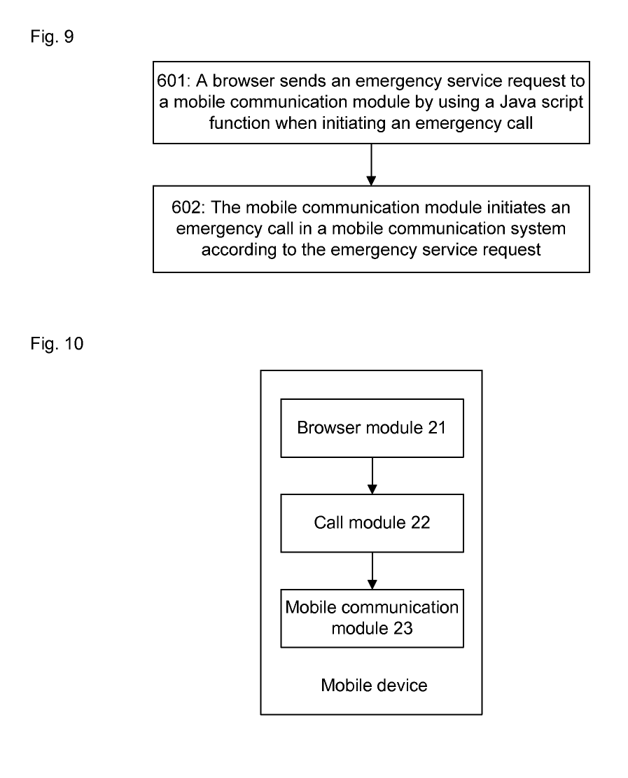

An embodiment of the disclosure further provides an emergency call method for a real-time communication browser in a mobile device. As shown in FIG. 9, the method includes the following steps:

In Step 601, a browser sends an emergency service request to a mobile communication module by using a Java script function when initiating an emergency call.

The step may further include: before sending the emergency service request to the mobile communication module by using the Java script function,

the browser determines that the current call request is an emergency service request according to a service code in the current call request; or

the browser sends the current call request to a signaling server, and the signaling server determines that the current call request is an emergency service request according to the service code in the current call request and returns an emergency service request with an emergency call identifier to the browser.

The emergency service request includes an emergency call number.

The mobile communication module may be: a Long Term Evolution (LTE) mobile communication module, a Code Division Multiple Access (CDMA) mobile communication module, a Wideband Code Division Multiple Access (WCDMA) mobile communication module, and a WiFi communication module etc.

In Step 602, the mobile communication module initiates an emergency call in a mobile communication system according to the emergency service request.

Specifically, the mobile communication module initiates the emergency call in the mobile communication system according to the service code included in the emergency service request.

An embodiment of the disclosure further provides a mobile device. As shown in FIG. 10, the mobile device includes a browser module 21, a call module 22 and a mobile communication module 23.

The browser module 21 is configured to send an emergency service request to the call module 22 when an emergency call is initiated;

the call module 22 is configured to send the emergency service request to the mobile communication module 23 by using a Java script function; and

the mobile communication module 23 is configured to initiate the emergency call in a mobile communication system according to the emergency service request.

The browser module 21 may be further configured to: before sending the emergency service request to the call module 22,

determine that the current call request is the emergency service request according to a service code in the current call request, or

send the current call request to a signaling server and receive an emergency service request with an emergency call identifier from the signaling server.

In the practical application, the browser module 21 may be implemented by a memory in the mobile device. The call module 22 may be implemented by a Central Processing Unit (CPU) in the mobile device. The mobile communication module 23 may be implemented by a baseband processor in the mobile device.

### INDUSTRIAL APPLICABILITY

To sum up, according to the solution of the embodiments of the disclosure, an emergency communication server may be deployed or a mobile communication network may be selected to initiate an emergency call through a browser, so as to implement a cross-region emergency call of an RTCWEB system.

The above are only the preferred embodiments of the disclosure, and are not intended to limit the scope of protection of the disclosure.

1. An emergency call method for a real-time communication browser, comprising:
acquiring, by a signaling server, location information of a user who makes an emergency call through a browser, determining an emergency communication server connected between the signaling server and a Public Safety Answering Point (PSAP) nearest to the user according to the location information, and sending an emergency service request to the emergency communication server or returning an emergency call request response to the browser that then sends an emergency service request to the emergency communication server; and
forwarding, by the emergency communication server, the emergency service request to the PSAP.

2. The method according to claim 1, wherein the acquiring location information of a user who makes an emergency call through a browser comprises:
receiving, by the signaling server, an emergency call request which is sent by the user through the browser, wherein the emergency call request includes an IP address of the user, longitude and latitude of a location of the browser, or a location parameter of a mobile user; and
acquiring the location information of the user according to the emergency call request.

3. The method according to claim 1, wherein the acquiring location information of a user who makes an emergency call through a browser comprises:
receiving, by the signaling server, an ordinary call request which is sent by a user through the browser, wherein the ordinary call request includes a service code and one of the following: an IP address of the user, longitude and latitude of a location of the browser, and a location parameter of a mobile user;
determining whether the ordinary call request is an emergency call request by determining whether the service code is an emergency call service code; and
when the ordinary call request is an emergency call request, acquiring the location information of the user according to the emergency call request.

4. The method according to claim 1, wherein the acquiring location information of a user who makes an emergency call through a browser comprises:
receiving, by the signaling server, an emergency call request which is sent by the user through the browser; and
acquiring the location information of the user through a location server.

5. The method according to claim 1, wherein the determining an emergency communication server connected between the signaling server and the PSAP nearest to the user according to the location information comprises:
searching for the PSAP nearest to the user through the Internet according to the location information; and
determining an IP address of the emergency communication server connected between the signaling server and the PSAP according to an route of the PSAP.

6. The method according to claim 1, wherein the emergency service request includes at least one of the following: information about the PSAP and the location information of the user, wherein the information about the PSAP is an IP address of the PSAP or number of the PSAP.

7. The method according to claim 1, further comprising:
responding to the emergency service request by the PSAP after the emergency service request is received, and returning an emergency service request response by the PSAP.

8. An emergency call system for a real-time communication browser, comprising: a browser, a signaling server, an emergency communication server, and a PSAP, wherein
the browser is configured to initiate an emergency call, and to send an emergency service request to the emergency communication server after receiving an emergency call request response;
the signaling server is configured to acquire location information of a user who makes an emergency call through the browser, to determine the emergency communication server connected between the signaling server and the PSAP nearest to the user according to the location information, and to send an emergency service request to the emergency communication server or return an emergency call request response to the browser;
the emergency communication server is configured to forward the emergency service request to the PSAP; and
the PSAP is configured to receive the emergency service request from the emergency communication server.

9. The system according to claim 8, wherein the signaling server is configured to: receive the emergency call request which is sent by the user through the browser, wherein the emergency call request includes an IP address of the user, longitude and latitude of a location of the browser, or a location parameter of a mobile user; and acquire the location information of the user who makes an emergency call through the browser according to the emergency call request.

10. The system according to claim 8, wherein the signaling server is configured to: receive an ordinary call request which is sent by a user through the browser, wherein the ordinary call request includes a service code and one of the following: an IP address of the user, longitude and latitude of a location of the browser, and a location parameter of the mobile user; determine whether the ordinary call request is an emergency call request by determining whether the service code is an emergency call service code; and, when the ordinary call request is an emergency call request, acquire the location information of the user who makes an emergency call through the browser according to the emergency call request.

11. The system according to claim 8, wherein the signaling server is configured to receive an emergency call request which is sent by the user through the browser and acquire the location information of the user through a location server.

12. The system according to claim 8, wherein the emergency service request includes at least one of the following: information about the PSAP, and the location information of the user, wherein the information about the PSAP is an IP address or number of the PSAP.

13. The system according to claim 8, wherein the PSAP is further configured to, after receiving the emergency service request, respond to the emergency service request and return an emergency service request response.

14. An emergency call method for a real-time communication browser, comprising:
sending, by a browser, an emergency service request to a mobile communication module by using a Java script function when an emergency call is to be initiated; and
initiating, by the mobile communication module, an emergency call in a mobile communication system according to the emergency service request.

15. The method according to claim 14, further comprising the step, before the sending the emergency service request to the mobile communication module by using the Java script function, of:
determining, by the browser, that a call request is an emergency service request according to a service code in the call request; or
sending, by the browser, a call request to a signaling server, and determining, by the signaling server, that the call request is an emergency service request according to a service code in the call request and returning an emergency service request with an emergency call identifier to the browser.

16. A mobile device, comprising: a browser module, a call module and a mobile communication module, wherein
the browser module is configured to send an emergency service request to the call module when an emergency call is to be initiated;
the call module is configured to send the emergency service request to the mobile communication module by using a Java script function; and
the mobile communication module is configured to initiate an emergency call in a mobile communication system according to the emergency service request.

17. The mobile device according to claim 16, wherein the browser module is further configured to: before sending the emergency service request to the call module,
determine that a call request is an emergency service request according to a service code in the call request; or
send a call request to a signaling server and receive an emergency service request with an emergency call identifier from the signaling server.
